(19) United States
(12) Patent Application Publication
(10) Pub. No.: US 2012/0047470 A1
(43) Pub. Date: Feb. 23, 2012

(54) METHOD AND APPARATUS FOR BROWSING AN ELECTRONIC BOOK ON A TOUCH SCREEN DISPLAY

(76) Inventor: Jean-Baptiste MARTINOLI, St-Anaclet-de-Lessard (CA)

(21) Appl. No.: 13/213,132

(22) Filed: Aug. 19, 2011

Related U.S. Application Data
(60) Provisional application No. 61/375,573, filed on Aug. 20, 2010.

(51) Int. Cl. G06F 3/048

(52) U.S. Cl. 715/863

(57) ABSTRACT

A method is disclosed for navigating in an electronic book comprising a plurality of pages, the method comprising displaying in an interface a first given page of the electronic book with a fore edge section representative of a fore edge of the electronic book; detecting a finger motion in the fore edge section and displaying a second given page of the electronic book wherein the second given page is displayed depending on characteristics of the detected finger motion in the fore edge section.

### CROSS-REFERENCE TO RELATED APPLICATIONS

This patent application claims priority of U.S. Patent Application No. 61/375,573, entitled “Method and apparatus for browsing an electronic book on a touch screen display” that was filed on Aug. 20, 2010, the specification of which is hereby incorporated by reference.

### FIELD OF THE INVENTION

The invention relates to methods for browsing data on a touch screen display. More precisely, the invention pertains to a method and apparatus for browsing an electronic book on a touch screen display.

### BACKGROUND

Electronic books have become more and more popular with the arrival of new devices such as handled devices. A user may access for instance an electronic version of a book using a program or application running on the devices and responsible for displaying the electronic version of the book on a display of the electronic devices.

Recent handheld devices having touch screen displays have also added more reality to the user experience since users can now use a finger to browse page by page the electronic version of the book.

For instance, iBook™ application available on Apple™ iPhone™ provides such program for browsing pages.

Unfortunately, the user is still faced with the issue of having to readily locate a given page of an electronic book which is not the next or the previous page of the book. Currently this can be achieved by accessing a table of content menu which gives an index to the user. This is very cumbersome and clearly affects the user experience.

In prior art embodiments, it is also cumbersome to randomly browse an electronic book when the user does not wish to access the next page or the previous page of a current page.

There is a need for a method that will overcome at least one of the above-identified drawbacks.

Features of the invention will be apparent from review of the disclosure, drawings and description of the invention below.

### BRIEF SUMMARY

According to an embodiment, there is provided a method for navigating in an electronic book comprising a plurality of pages, the method comprising displaying in an interface a first given page of the electronic book with a fore edge section representative of a fore edge of the electronic book; detecting a finger motion in the fore edge section and displaying a second given page of the electronic book wherein the second given page is selected and displayed depending on characteristics of the detected finger motion in the fore edge section.

In accordance with an embodiment, the characteristics of the detected finger motion comprise a finger motion direction and a finger motion duration, and the second given page is selected such that an amount of pages between the first given page and the second given page is proportional to the finger motion duration.

In accordance with yet another embodiment, the characteristics of the detected finger motion comprise a finger position on the fore edge section prior the finger motion and the second given page is selected according to the finger position on the fore edge section.

In accordance with yet another embodiment, the detecting of a finger motion comprises detecting a linear motion of a finger over a given distance on the fore edge section.

In accordance with another embodiment, the fore edge section has a rectangular shape.

In accordance with another embodiment, the fore edge section has a trapezoidal shape.

In accordance with yet another embodiment, the fore edge section is displayed according to parameters selected by a user.

In accordance with another embodiment, the fore edge section has a size representative of a number of pages of the electronic book located below the first given page.

In accordance with another aspect of the invention, there is provided a computer-readable storage medium storing computer-executable instructions which, when executed, cause a computing device to perform a method for navigating in an electronic book comprising a plurality of pages, the method comprising displaying in an interface a first given page of the electronic book with a fore edge section representative of a fore edge of the electronic book, detecting a finger motion in the fore edge section, and displaying a second given page of the electronic book wherein the second given page is selected and displayed depending on characteristics of the detected finger motion in the fore edge section.

In accordance with another aspect of the invention, there is provided a computing device, the computing device comprising a display device; one or more central processing units; a memory comprising an application; and one or more programs, wherein the one or more programs are stored in the memory and configured to be executed by the one or more central processing units, the one or more programs including instructions for displaying in an interface a first given page of an electronic book with a fore edge section representative of a fore edge of the electronic book; instructions for detecting a finger motion in the fore edge section; and instructions for displaying a second given page of the electronic book wherein the second given page is selected and displayed depending on characteristics of the detected finger motion in the fore edge section.

In accordance with an embodiment, the electronic book has a plurality of pages comprising objects selected from a group consisting of text, graphics, images, animations, interactive elements, sound and videos.

An advantage of one embodiment of the method disclosed is that a user may readily access any given page of the electronic book.

Another advantage of an embodiment of the method disclosed is that a user may readily access a given page in an intuitive manner.

Another advantage of an embodiment of the method disclosed is that a user may skip pages by a given amount using intuitive finger gestures.

### BRIEF DESCRIPTION OF THE DRAWINGS

The invention will be understood and appreciated more fully from the following detailed description of embodiments of the invention, taken in conjunction with the accompanying drawings of which:

FIG. 1 is a block diagram of an embodiment of an apparatus in which a method for browsing an electronic book on a touch screen display may be implemented:

FIG. 2 is a flowchart which shows an embodiment of a method for browsing an electronic book on a touch screen display; according to a first step a first given page is displayed; according to a second step a finger motion is detected and according to a third step a second given page is selected and displayed in accordance with the characteristics of the finger motion;

FIG. 3 is a flowchart which shows an embodiment of how the finger motion is detected;

FIG. 4 is a diagram which shows an example of a user interface in which an electronic book is displayed;

FIG. 5a is a diagram which shows an example of a user interface in which an electronic book is displayed and in which the electronic book has been opened at a first given page;

FIG. 5b is a diagram which shows an example of a user interface in which the electronic book is displayed and has been opened at a second given page using one embodiment of the method disclosed herein;

FIG. 6 is a diagram which shows an enlarged view of a fore edge of an electronic book showing a location where a user has put a finger and concurrently made a finger motion; and

FIG. 7 is a diagram which shows a plurality of fingers motions made on the fore edge of a page of an electronic book.

It will be appreciated that for simplicity and clarity of illustration, elements shown in the figures have not necessarily been drawn accurately or to scale. For example, the dimensions of some of the elements may be exaggerated relative to other elements for clarity or several physical components included in one element. Further, where considered appropriate, reference numerals may be repeated among the figures to indicate corresponding or analogous elements. It will be appreciated that these figures present examples of embodiments of the present invention and are not intended to limit the scope of the invention. Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

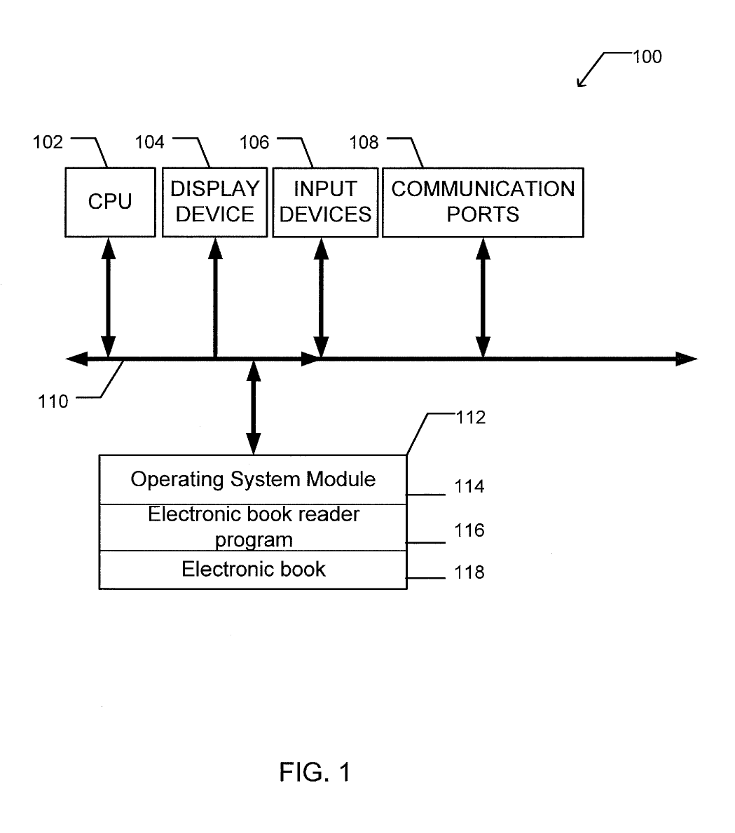

Now referring to FIG. 1, there is shown an embodiment of an apparatus 100 in which an embodiment of the method for browsing an electronic book on a touch screen display may be implemented. The skilled addressee will appreciate that various embodiments may be alternatively provided depending on various considerations departing from the scope of this application.

In this embodiment the apparatus 100 comprises a Central Processing Unit (CPU) 102, a display device 104, input devices 106, communication ports 108, a data bus 110 and a memory 112.

The Central Processing Unit 102, the display device 104, the input devices 106, communication ports 108 and the memory 112 are connected together using the data bus 110.

In one embodiment the apparatus 100 is the ExoPC™ manufactured by Pegatron. Still in this embodiment the Central Processing Unit 102 is Atom Pineview-M N450 manufactured by Intel™, running at 1.66 GHz and supporting 64 bits.

Still in this embodiment, the display device 104 comprises a touch screen display, an example of which is a touch screen panel having 11.6-inch width and a resolution of 1366×768 pixels with 135 pixels per inch. The touch screen panel uses a multipoint capacitive technology known to the ones skilled in the art. The display device 104 further comprises a GMA500 graphics card manufactured by Intel™.

The input devices 106 are used for providing data to the apparatus 100.

In this embodiment, the input devices 106 comprise an accelerometer, a microphone, a luminosity sensor and a camera. The skilled addressee will appreciate that various other embodiments for the input devices 106 may alternatively be provided.

The communications ports 108 are used for enabling a communication of the apparatus 100 with other devices.

In this embodiment, the communication ports 108 comprise a WIFI 802.11b/g/n port, a Bluetooth 2.1+ EDR port, two USB 2.0 ports, a SD/SDHC card reader and a mini HDMI port. The skilled addressee will again appreciate that various other embodiments may be provided for the communication ports 108.

The memory 112 is used for storing data.

In this embodiment, the memory 112 comprises a Solid State Drive (SSD) having a capacity of either 32 or 64 GB.

More precisely and still in this embodiment, the memory 112 comprises, inter alia, an operating system module 114. The operating system module 114 is Windows 7™ Home Premium Edition manufactured by Microsoft™.

The memory 112 further comprises an electronic book reader program 116. The electronic book reader program 116 is used for providing electronic books 118 to a user. It will be appreciated that the method for browsing an electronic book on a touch screen display may be implemented within the electronic book reader program 116. In such embodiment, the electronic book reader program 116 comprises instructions for displaying, in an interface, a first given page of an electronic book with a fore edge section representative of a fore edge of the electronic book. The electronic book reader program 116 further comprises instructions for detecting a finger motion in the fore edge section and instructions for displaying a second given page of the electronic book wherein the second given page is selected and displayed depending on characteristics of the detected finger motion in the fore edge section.

Alternative embodiments may be possible. For instance, the method for browsing an electronic book on a touch screen display could be implemented within the operating system module 114.

It will be appreciated that the memory 112 further comprises electronic books 118 which can be displayed within the touch screen display using the electronic book reader program 116.

It will be appreciated by the skilled addressee that an electronic book should be understood as a plurality of pages comprising objects selected from a group consisting of text, graphics, images, animations, interactive elements, sound, videos etc.

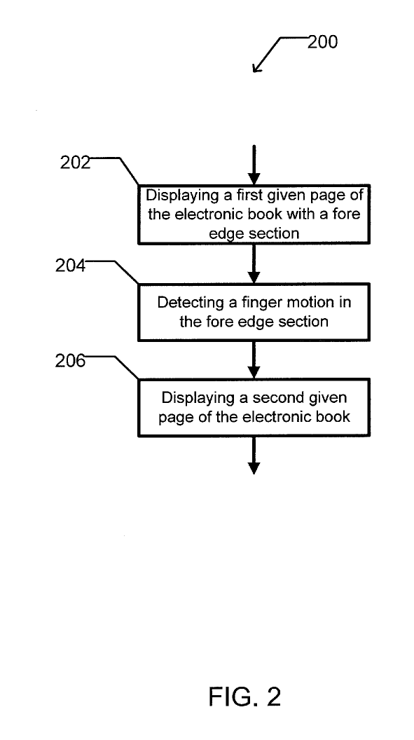

Now referring to FIG. 2, there is shown an embodiment of a method for browsing an electronic book on a touch screen display.

According to processing step 202 a first given page of an electronic book is displayed together with a corresponding fore edge section.

It will be appreciated by the skilled addressee that the fore edge section may be displayed according to various embodiments. In particular the fore edge section may have a geometry which varies depending on the perspective of the electronic book presented to the user. Alternatively, the fore edge section may be displayed according to various parameters selected by the user. The parameters may comprise aesthetic considerations or user preferences.

For instance and in one embodiment, the fore edge section may have a rectangular shape having one edge of the two longer edges of the rectangular shape which is adjacent to the outside vertical edge of a corresponding page of the electronic book. In an alternative embodiment, the fore edge section may have a trapezoidal shape and one edge of the two longer edges of the trapezoidal shape may be adjacent to the outside vertical edge of a corresponding page of the electronic book. The skilled addressee will appreciate that many alternative embodiments may be provided.

Also, in one embodiment a single page may be displayed with a corresponding fore edge section. Alternatively two pages may be displayed side by side, each having a corresponding a fore edge section as shown further below. In such embodiment a page located on the right will usually follow in chronology the page on the left unless the electronic book is written in a specific language such as Hebrew or Arabic where a user reads from right to left.

It will be appreciated that the fore edge section is representative of a number of pages located below a corresponding page. The fore edge section may further comprise additional elements such as bookmarks, etc.

In fact, it will be appreciated that the fore edge section may have a size representative of a number of pages of the electronic book located below the corresponding page.

Still referring to FIG. 2 and according to processing step 204, a finger motion is detected in the fore edge section.

As mentioned above and in one embodiment, two pages of an electronic book may be displayed side by side. In such embodiment, a finger motion may be detected in a corresponding fore edge section of anyone of the two pages.

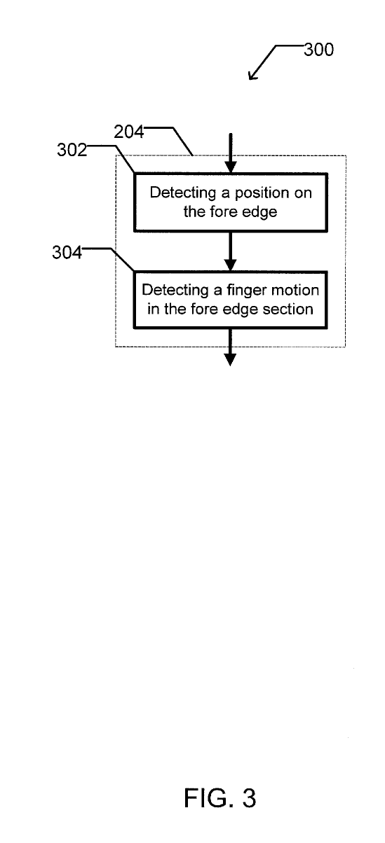

Now referring to FIG. 3, there is shown an embodiment showing how a finger motion may be detected.

According to processing step 302, a finger position is detected on the fore edge section.

It will be appreciated that processing step 302 is optional. In fact, the skilled addressee will appreciate that knowing the position of a finger on the fore edge section may be useful for determining at which given page a user wishes to go to in the electronic book.

In fact, depending on the relative distance of the finger position with respect to each of the two vertical edges of the fore edge section, it is possible to determine a corresponding given page where the user wishes to navigate to in the electronic book. The skilled addressee will appreciate that depending on the number of pages in the fore edge section and the width of the fore edge section it may be difficult for a user to go precisely to a given page. This is not an issue since the method disclosed herein provides, in one embodiment, the user with further tools to then skip pages in an appropriate manner to finally reach the intended page.

According to processing step 304, a finger motion is detected in the fore edge section.

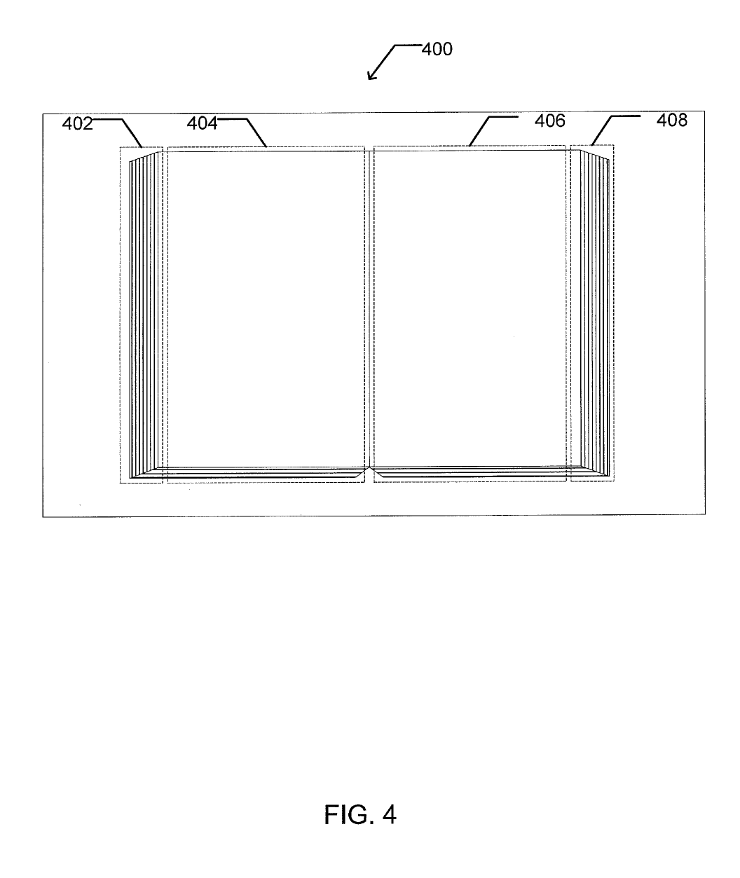

Now referring to FIG. 4, there is shown an example of a user interface in which an electronic book is displayed.

The electronic book displayed comprises a first page section 404, a second page section 406, a first page fore edge section 402 and a second page fore edge section 408.

The second page section 406 is located adjacently to the first page section 404. In the embodiment shown in FIG. 4, the second page section 406 is located on the right of the first page section 404.

Still in this embodiment, the first page section 404 is located adjacently to the first page fore edge section 402. More precisely and in this embodiment the first page section 404 is located on the right of the first page fore edge section 402.

The first page fore edge section 402 is representative of a number of pages located below the first page section 404.

Similarly, the second page section 406 is located adjacently to the second page fore edge section 408. More precisely and in this embodiment the second page fore edge section 408 is located on the right of the second page section 406.

The second page fore edge section 408 is representative of a number of pages located below the second page section 406.

The skilled addressee will appreciate that various alternative embodiments may be possible.

Still in one embodiment, the vertical width of the first page fore edge section 402 and the second page fore edge section 408 is representative of an amount of pages available for display below respectively each of the first page section 404 and the second page section 406.

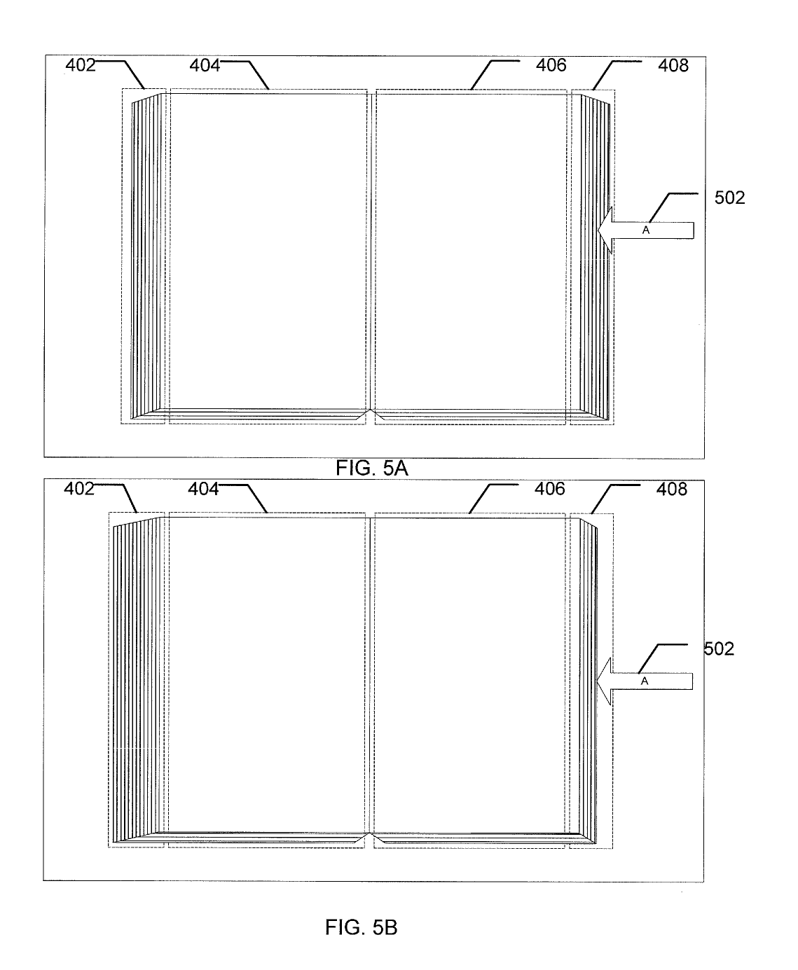

Now referring to FIG. 5a, there is shown an embodiment of an electronic book displayed in which a user has placed a finger, symbolically represented by arrow 502, in the second page fore edge section 408.

It will be appreciated that following such step and a given finger motion, what is displayed in the first page section 404 and the second page section 406 will change in accordance with processing step 206 of FIG. 2 to match what is available at the location of the electronic book located where the user has placed the finger.

Accordingly and as not shown at FIG. 5b what is displayed in the first page section 404 of FIG. 5a is different than what is displayed in the first page section 404 of FIG. 5b. Similarly, what is displayed in the second page section 406 of FIG. 5a is different than what is displayed in the second page section 406 of FIG. 5b.

The skilled addressee will further appreciate that, as shown in FIG. 5b, the width of the second page fore edge section 408 has been reduced in proportion of the number of pages moved. Similarly, the width of the first page fore edge section 402 has been increased in proportion of the number of pages moved. Alternatively, the width of each of the first page fore edge section 402 and the second page fore edge section 408 may not change.

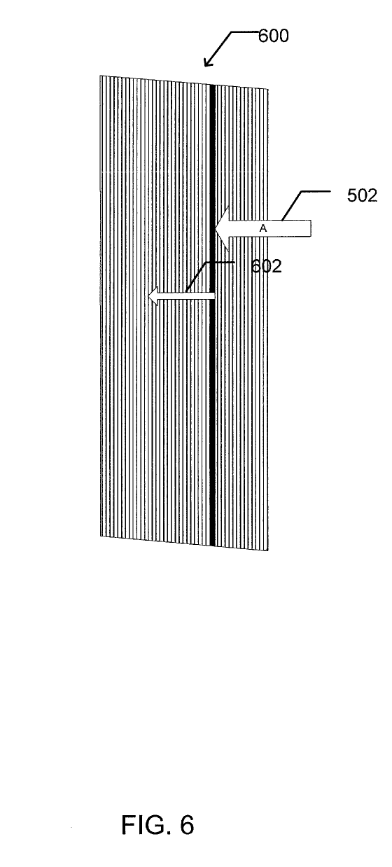

Referring to FIG. 6, there is shown an embodiment of the second page fore edge section 600. As shown a user may place a finger, shown symbolically with arrow 502. In such case and in one embodiment, it is as if the user selects a given page to go to. Actually the user could have selected the same page if the finger 502 would have been positioned on a vertical line shown in bold in FIG. 5.

As shown in FIG. 6, by adding a finger motion 602, the page displayed in the corresponding second page section 406 will be changed to be the one selected using finger 502.

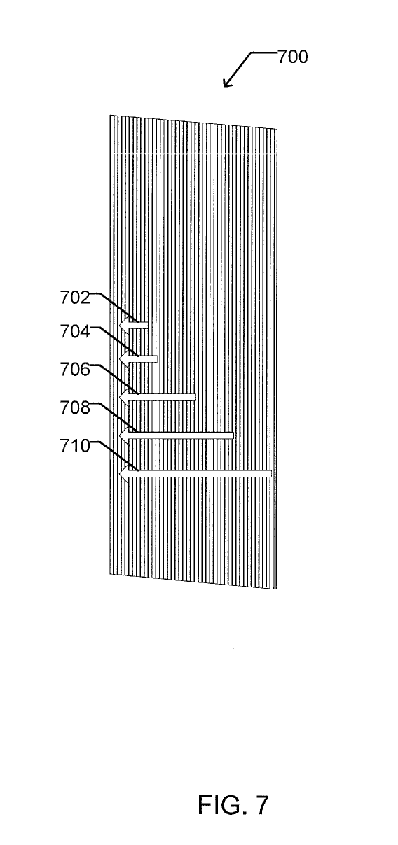

Now referring to FIG. 7, there is shown an alternative embodiment wherein only finger motion is used to change from a first given page to a second given page, i.e. to skip pages by a given amount of pages.

As shown in FIG. 7, various finger motions may be performed to skip pages. A first finger motion 702 performed over a first path may be used to swap a corresponding page by a first given amount of pages.

Another finger motion 704 performed over a second path longer, i.e. corresponding to an increased finger motion duration, than the path of the first finger motion 702 may be used to skip a corresponding page by a second given amount of pages larger than the first given amount of pages.

Accordingly, the second given page may be selected such that an amount of pages between the first given page and the second given page is proportional to the finger motion direction.

The skilled addressee will appreciate that finger motions 702 to 710 are performed in a given direction to skip pages in a corresponding given finger motion direction. Alternatively, the finger motions may be performed in another direction opposite to the first given finger motion direction to perform the skipping of the pages in the other direction opposite from the first given direction.

The skilled addressee will appreciate that various other embodiments may be possible for skipping pages and that the user may associate selected characteristics of a detected finger motion to a desired result for skipping pages in order to obtain an enjoyable user experience when navigating en electronic book. For instance, the speed of the finger motion may be used in addition to the path of the finger motion.

The skilled addressee will appreciate that the methods disclosed herein are of great advantage for readily navigating in an electronic book.

Also, it will be appreciated that a computer-readable storage medium may be provided for storing computer-executable instructions. Such computer-executable instructions would cause a computing device, when executed, to perform a method for navigating in an electronic book comprising a plurality of pages, the method comprising displaying, in an interface, a first given page of the electronic book with a fore edge section representative of a fore edge of the electronic book, detecting a finger motion in the fore edge section and displaying a second given page of the electronic book wherein the second given page is selected and displayed depending on characteristics of the detected finger motion in the fore edge section.

Although some of the exemplary devices, systems and/or methods described above are described in the context of devices for reproducing five primary colors, it will be appreciated by those skilled in the art, that similar devices, systems and/or methods may be implemented, with appropriate changes, in conjunction with devices for reproducing more or less than five primary colors. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for navigating in an electronic book comprising a plurality of pages, the method comprising:
displaying in an interface a first given page of the electronic book with a fore edge section representative of a fore edge of the electronic book;
detecting a finger motion in the fore edge section; and
displaying a second given page of the electronic book wherein the second given page is selected and displayed depending on characteristics of the detected finger motion in the fore edge section.

2. The method as claimed in claim 1, wherein the characteristics of the detected finger motion comprise a finger motion direction and a finger motion duration, further wherein the second given page is selected such that an amount of pages between the first given page and the second given page is proportional to the finger motion duration.

3. The method as claimed in claim 1, wherein the characteristics of the detected finger motion comprise a finger position on the fore edge section prior the finger motion, further wherein the second given page is selected according to the finger position on the fore edge section.

4. The method as claimed in claim 1, wherein the detecting of a finger motion comprises detecting a linear motion of a finger over a given distance on the fore edge section.

5. The method as claimed in claim 1, wherein the fore edge section has a rectangular shape.

6. The method as claimed in claim 1, wherein the fore edge section has a trapezoidal shape.

7. The method as claimed in claim 1, wherein the fore edge section is displayed according to parameters selected by a user.

8. The method as claimed in claim 1, wherein the fore edge section has a size representative of a number of pages of the electronic book located below the first given page.

9. A computer-readable storage medium storing computer-executable instructions which, when executed, cause a computing device to perform a method for navigating in an electronic book comprising a plurality of pages, the method comprising:
displaying in an interface a first given page of the electronic book with a fore edge section representative of a fore edge of the electronic book;
detecting a finger motion in the fore edge section; and
displaying a second given page of the electronic book wherein the second given page is selected and displayed depending on characteristics of the detected finger motion in the fore edge section.

10. The computer-readable storage medium as claimed in claim 9, wherein the characteristics of the detected finger motion comprise a finger motion direction and a finger motion duration, further wherein the second given page is selected such that an amount of pages between the first given page and the second given page is proportional to the finger motion duration.

11. The computer-readable storage medium as claimed in claim 9, wherein the characteristics of the detected finger motion comprise a finger position on the fore edge section prior the finger motion, further wherein the second given page is selected according to the finger position on the fore edge section.

12. The computer-readable storage medium as claimed in claim 9, wherein the detecting of a finger motion comprises detecting a linear motion of a finger over a given distance on the fore edge section.

13. The computer-readable storage medium as claimed in claim 9, wherein the fore edge section has a rectangular shape.

14. The computer-readable storage medium as claimed in claim 9, wherein the fore edge section has a trapezoidal shape.

15. The computer-readable storage medium as claimed in claim 9, wherein the fore edge section has a size representative of a number of pages of the electronic book located below the first given page.

16. A computing device, comprising:
a display device;
one or more central processing units;
a memory comprising an application; and
one or more programs, wherein the one or more programs are stored in the memory and configured to be executed by the one or more central processing units, the one or more programs including:
instructions for displaying in an interface a first given page of an electronic book with a fore edge section representative of a fore edge of the electronic book;
instructions for detecting a finger motion in the fore edge section; and
instructions for displaying a second given page of the electronic book wherein the second given page is selected and displayed depending on characteristics of the detected finger motion in the fore edge section.

17. The computing device as claimed in claim 16, wherein the characteristics of the detected finger motion comprise a finger motion direction and a finger motion duration, further wherein the second given page is selected such that an amount of pages between the first given page and the second given page is proportional to the finger motion duration.

18. The computing device as claimed in claim 16, wherein the characteristics of the detected finger motion comprise a finger position on the fore edge section prior the finger motion, further wherein the second given page is selected according to the finger position on the fore edge section.

19. The computing device as claimed in claim 16, wherein the detecting of a finger motion comprises detecting a linear motion of a finger over a given distance on the fore edge section.

20. The method as claimed in claim 1, wherein the electronic book has a plurality of pages comprising objects selected from a group consisting of text, graphics, images, animations, interactive elements, sound and videos.
